(19) United States
(12) Patent Application Publication
(10) Pub. No.: US 2026/0366185 A1
(43) Pub. Date: Nov. 19, 2026

(54) SYSTEMS AND METHODS FOR ELECTROREFINING LITHIUM FROM LITHIUM SOURCES

(71) Applicant: Pure Lithium Corporation, Chicago, IL (US)

(72) Inventors: Donald R. SADOWAY, Chicago, IL (US); Adam LADELPHIA, Chicago, IL (US)

(21) Appl. No.: 19/412,019

(22) Filed: Dec. 8, 2025

Related U.S. Application Data
(60) Provisional application No. 63/730,253, filed on Dec. 10, 2024.

(51) Int. Cl. C25C 3/02; C22B 7/00; C22B 26/12; C25C 7/02; C25C 7/06; H01M 4/04; H01M 4/38

(52) U.S. Cl. CPC C25C 3/02; C22B 7/001; C22B 26/12; C25C 7/025; C25C 7/06; H01M 4/0435; H01M 4/0438; H01M 4/382

(57) ABSTRACT

In some aspects, the present disclosure provides a method of making a lithium metal electrode. The method can comprise electrorefining a lithium source to produce lithium metal. The lithium metal can be deposited onto a substrate during the electrorefining process.

### CROSS-REFERENCE

This application claims the benefit of U.S. Provisional Application No. 63/730,253, filed Dec. 10, 2024, which is incorporated by reference herein in its entirety.

### BACKGROUND

Lithium ion batteries (LIBs) are ubiquitous for use in consumer electronics and electrical vehicles. The battery lifetimes of lithium ion batteries are, generally, less than three years in consumer electronics, and between five to ten years in electric vehicles. Despite lithium being a valuable and critical resource, less than 5% of lithium ion batteries are currently recycled. Most lithium ion batteries are discarded in landfills. As demands for lithium ion batteries expand (e.g., electrical vehicles), the amount of lithium ion battery waste is expected to increase as well. Thus, recycling lithium ion batteries, as well as other sources of lithium waste, presents an opportunity for minimizing waste, while recovering valuable lithium.

### SUMMARY

Provided herein is a method of making a lithium metal electrode, comprising: electrorefining a lithium source to produce liquid lithium metal; contacting a substrate with the liquid lithium metal to adhere at least a fraction of the liquid lithium metal on the substrate; and separating the substrate and the fraction of the liquid lithium metal from the liquid lithium metal to produce the lithium metal electrode.

In some embodiments, the method further comprises pretreating the substrate. In some embodiments, the pretreating comprises mechanically abrading the surface of the substrate.

In some embodiments, the mechanically abrading is performed using a wire brush, sandpaper, media blasting, plasma cleaning, or any combination thereof. In some embodiments, the pretreating comprises chemically cleaning the substrate to remove kerf from the surface. In some embodiments, the chemically cleaning is performed using a molten salt bath, an acidic or a caustic wash, electropolishing, a functional coating, or any combination thereof.

In some embodiments, the contacting is performed at a temperature of at least 180.5 °C, 200 °C, 250 °C, 300 °C, 350 °C, 400 °C, 500 °C, 600 °C, 700 °C, 800 °C, or 900 °C. In some embodiments, the contacting is performed at a temperature of at most 200 °C, 250 °C, 300 °C, 350 °C, 400 °C, 500 °C, 600 °C, 700 °C, 800 °C, 900 °C, 1000 °C. In some embodiments, the contacting comprises moving the substrate through the liquid lithium metal. In some embodiments, the contacting comprises contacting the substrate with the liquid lithium metal on two sides of the substrate.

In some embodiments, the method further comprises quenching the lithium metal electrode. In some embodiments, the quenching solidifies the fraction of the liquid lithium metal on the substrate into solid lithium metal. In some embodiments, the quenching is performed using a heat sink. In some embodiments, the heat sink comprises cooled copper or aluminum. In some embodiments, the heat sink comprises a roller.

In some embodiments, the method further comprises calendaring the lithium metal electrode.

In some embodiments, the method further comprises cleaning the lithium metal electrode.

In some embodiments, the method further comprises cutting the lithium metal electrode.

In some embodiments, the method further comprises forming a solid electrolyte interphase on a surface of the lithium metal electrode.

In some embodiments, the method further comprises treating the lithium metal electrode with an imposed solid, a liquid, or a powder.

In some embodiments, the lithium source comprises LiFePO₄. In some embodiments, the lithium source comprises lithium scrap, lithium waste, battery waste, or any combination thereof. In some embodiments, the substrate comprises copper, a copper alloy, aluminum, an aluminum alloy, titanium, a titanium alloy, stainless steel, or any combination thereof. In some embodiments, the substrate comprises a melting point higher than the melting point of lithium metal. In some embodiments, the substrate comprises a material web. In some embodiments, the substrate comprises a foil, a mesh, a cloth, or a foam.

In some embodiments, the contacting forms an alloy between the fraction of the liquid lithium metal and the substrate. In some embodiments, the alloy is formed at an interface between the fraction of the liquid lithium metal and the substrate. In some embodiments, the alloy comprises lithium and copper.

In some embodiments, the electrorefining comprising using an electrolyte that separates the lithium source from the liquid lithium metal. In some embodiments, the electrolyte comprises a molten salt. In some embodiments, a temperature of the electrolyte is at least 180.5 °C, 200 °C, 250 °C, 300 °C, 350 °C, 400 °C, 500 °C, 600 °C, 700 °C, 800 °C, or 900 °C. In some embodiments, the contacting is performed at a temperature of at most 200 °C, 250 °C, 300 °C, 350 °C, 400 °C, 500 °C, 600 °C, 700 °C, 800 °C, 900 °C, 1000 °C.

In some embodiments, the method further comprises alloying the lithium source with a metal before electrorefining. In some embodiments, the lithium source is positioned below the electrolyte. In some embodiments, the lithium source has a higher density than the electrolyte. In some embodiments, the liquid lithium metal is positioned above the electrolyte. In some embodiments, the lithium source is positioned above the electrolyte. In some embodiments, the lithium source has a lower density than the electrolyte. In some embodiments, the liquid lithium metal is positioned below the electrolyte. In some embodiments, the metal is denser than lithium. In some embodiments, the metal comprises Sn, Pb, Bi, Sb, Zn, or any combination thereof.

In some embodiments, the electrorefining is performed using a polarized electrode configured to attract lithium ions, from the lithium source positioned below the electrolyte, to the liquid lithium metal positioned above the electrolyte. In some embodiments, the electrorefining reduces the lithium ions to produce the liquid lithium metal.

In certain aspects, the present disclosure provides a method of making a lithium metal electrode, comprising: electrochemically stripping a lithium source to enrich a molten salt with lithium ions; and electrochemically depositing the lithium ions as lithium metal onto a substrate, wherein the substrate is in contact with the molten salt.

In some embodiments, the electrochemically stripping and the electrochemically depositing is performed simultaneously. In some embodiments, the electrochemically stripping and the electrochemically depositing are performed within the same electrochemical cell. In some embodiments, the lithium source and the substrate are in contact with the molten salt at the same time. In some embodiments, the lithium source and the substrate are electrically polarized. In some embodiments, the lithium source is polarized positively, and the substrate is polarized negatively. In some embodiments, the lithium metal is deposited as a liquid. In some embodiments, the electrochemically depositing is performed a temperature above the melting point of lithium metal. In some embodiments, the lithium metal is deposited as a solid. In some embodiments, the electrochemically depositing is performed a temperature below the melting point of lithium metal.

In some embodiments, the method further comprises alloying the lithium source with a metal before the electrochemically stripping. In some embodiments, the alloyed lithium source is positioned below the molten salt. In some embodiments, the alloyed lithium source has a higher density than the molten salt. In some embodiments, the metal higher density than lithium. In some embodiments, the metal comprises Sn, Pb, Bi, Sb, Zn, or any combination thereof.

In some embodiments, the lithium source is positioned above the molten salt. In some embodiments, the lithium source has a lower density than the molten salt. In some embodiments, the molten salt comprises Li⁺, Na⁺, K⁺, Mg⁺², Al⁺³, B⁺³, or any combination thereof, and Cl⁻, F⁻, Br⁻, or any combination thereof.

In some embodiments, the lithium source comprises LiFePO₄. In some embodiments, the lithium source comprises lithium scrap, lithium waste, battery waste, lithium metal, lithium alloy, liquid lithium metal, or any combination thereof.

In some embodiments, the method further comprises removing impurities from the top surface of the molten salt.

In some embodiments, the method further comprises removing impurities from the top surface of the lithium source.

In some embodiments, the method further comprises removing impurities from the interface between the lithium source and the molten salt. In some embodiments, the removing comprises scraping the surface.

In some embodiments, the method further comprises further comprising removing impurities from the bottom of the lithium source. In some embodiments, the removing comprises tapping off the bottom.

In some embodiments, the electrochemical deposition is performed while moving the substrate through the liquid lithium metal. In some embodiments, the lithium source comprises liquid lithium metal.

In some embodiments, the method further comprises producing the liquid lithium metal by melting lithium metal in lithium scrap, lithium waste, battery waste, lithium alloy, or any combination thereof.

In some embodiments, the method further comprises incorporating the lithium metal electrode into a lithium metal battery. In some embodiments, the lithium metal electrode is incorporated into the lithium metal battery at a distance of less than 10, 9, 8, 7, 6, 5, 4, 3, 2, or 1 km from where the lithium metal electrode is produced.

In certain aspects, the present disclosure also provides a system for making a lithium metal electrode, comprising: an electrochemical cell configured to electrorefine a lithium source to produce liquid lithium metal; and a substrate in contact with the liquid lithium metal.

In some embodiments, the system further comprises a conveyor configured to convey the substrate through the liquid lithium metal. In some embodiments, the conveyor comprises a plurality of rollers. In some embodiments, a roller in the plurality of rollers is domed or formed to keep tabs of the substrate out of the liquid lithium metal. In some embodiments, a roller in the plurality of rollers is at least partially submerged in the liquid lithium metal. In some embodiments, a roller in the plurality of rollers is configured to allow the substrate to be submerged in the liquid lithium metal. In some embodiments, a roller in the plurality of rollers comprises a predetermined gap to calendar the lithium metal electrode. In some embodiments, a roller in the plurality of rollers comprises a lithiophilic surface. In some embodiments, the lithiophilic surface provides a wetting angle of greater than 90°.

In some embodiments, the system further comprises a quencher. In some embodiments, the quencher comprises chilled heat sink. In some embodiments, the heat sink comprises copper or aluminum. In some embodiments, the quencher comprises a chilled roller.

In certain aspects, the present disclosure provides a system for making a lithium metal electrode, comprising: an electrochemical cell configured to: electrochemically strip a lithium source to produce a molten salt comprising lithium; and electrochemically deposit lithium metal onto a substrate in contact with the molten salt.

In some embodiments, the system further comprises a conveyor configured to convey the substrate through the molten salt. In some embodiments, the conveyor comprises a plurality of rollers. In some embodiments, a roller in the plurality of rollers is domed or formed to keep tabs of the substrate out of the liquid lithium metal. In some embodiments, a roller in the plurality of rollers is at least partially submerged in the liquid lithium metal. In some embodiments, a roller in the plurality of rollers is configured to allow the substrate to be submerged in the liquid lithium metal. In some embodiments, a roller in the plurality of rollers comprises a predetermined gap to calendar the lithium metal electrode. In some embodiments, a roller in the plurality of rollers comprises a lithiophilic surface. In some embodiments, the lithiophilic surface provides a wetting angle of greater than 90°.

In some embodiments, the system further comprises a quencher. In some embodiments, the quencher comprises chilled heat sink. In some embodiments, the heat sink comprises copper or aluminum. In some embodiments, the quencher comprises a chilled roller.

In some embodiments, the system further comprises a mechanical abrader configured to pretreat the substrate.

In some embodiments, the system further comprises a chemical cleaner configured to clean the substrate. In some embodiments, the chemical cleaner comprises a molten salt bath, an acidic or a caustic wash, electropolisher, a functional coating depositor or former, or any combination thereof. In some embodiments, the electrochemical cell is held at a temperature of at least 180.5 °C, 200 °C, 250 °C, 300 °C, 350 °C, 400 °C, 500 °C, 600 °C, 700 °C, 800 °C, or 900 °C. In some embodiments, the electrochemical cell is held at a temperature of at most 200 °C, 250 °C, 300 °C, 350 °C, 400 °C, 500 °C, 600 °C, 700 °C, 800 °C, 900 °C, or 1000 °C.

In some embodiments, the lithium source comprises LiFePO₄. In some embodiments, the lithium source comprises lithium scrap, lithium waste, battery waste, lithium metal, liquid lithium metal, lithium alloy, or any combination thereof. In some embodiments, the substrate comprises copper, a copper alloy, aluminum, an aluminum alloy, titanium, a titanium alloy, stainless steel, or any combination thereof. In some embodiments, the substrate comprises a melting point higher than the melting point of lithium metal. In some embodiments, the substrate comprises a material web. In some embodiments, the substrate comprises a foil, a mesh, a cloth, or a foam. In some embodiments, the contacting forms an alloy between the fraction of the liquid lithium metal and the substrate. In some embodiments, the electrochemical cell comprises an electrolyte. In some embodiments, the electrolyte comprises a molten salt. In some embodiments, the molten salt comprises Li⁺, Na⁺, K⁺, Mg⁺², Al⁺³, B⁺³, or any combination thereof, and Cl⁻, F⁻, Br⁻, or any combination thereof.

In some embodiments, the system further comprises a mixer or a furnace configured to alloy the lithium source with a metal. In some embodiments, the metal comprises Sn, Pb, Bi, Sb, Zn, or any combination thereof. In some embodiments, the deposited lithium metal is a liquid. In some embodiments, the deposited lithium metal is a solid.

In some embodiments, the system further comprises a scraper or a tap configured to remove impurities from the electrochemical cell. In some embodiments, the lithium source comprises liquid lithium metal.

In some embodiments, the system further comprises a compartment configured to produce the liquid lithium metal by melting lithium metal in lithium scrap, lithium waste, battery waste, lithium alloy, or any combination thereof. In some embodiments, the compartment comprises a heating element configured to melt the lithium metal. In some embodiments, the heating element comprises a resistive heating element.

In some embodiments, the system further comprises a tundish configured to hold the liquid lithium metal. In some embodiments, the tundish comprises an open bottom. In some embodiments, the liquid lithium metal is in contact with the electrolyte. In some embodiments, the system is operatively coupled to a lithium metal battery manufacturing system. In some embodiments, the system and the lithium metal battery manufacturing system is contained in an area of no greater than 10, 9, 8, 7, 6, 5, 4, 3, 2, or 1 km².

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a system for electrorefining lithium metal, in accordance with some embodiments.

FIG. 2 shows a system for electrorefining lithium metal, in accordance with some embodiments.

FIG. 3 shows a schematic of a system for electrorefining lithium metal to make liquid lithium metal, in accordance with some embodiments.

FIG. 4 shows a schematic of a system for contacting a substrate with liquid lithium metal.

FIG. 5 shows a schematic of a system for contacting a substrate with a molten salt enriched with lithium ions.

FIG. 6 shows a schematic of a system for contacting a substrate with a molten salt enriched with lithium ions.

### DETAILED DESCRIPTION

Lithium ion batteries (LIBs) are ubiquitously used in energy storage applications. Some common applications include consumer electronics and electrical vehicles. The battery lifetimes of lithium ion batteries can be less than three years for consumer electronics, and between five to ten years for electric vehicles. Despite lithium is a valuable and critical resource for mobile energy storage applications, currently, less than 5% of lithium ion batteries are currently recycled. Instead, most lithium ion batteries are discarded in landfills. Since demands for lithium ion batteries are expanding (e.g., in the electrical vehicle industry), the amount of lithium ion battery waste is expected to increase as well. Thus, there is a recognized need for systems and methods for recycling lithium ion batteries, as well as other kinds of lithium-containing waste, in order to minimize waste and recover valuable lithium.

However, recovering lithium from waste presents various challenges. Lithium ion batteries are highly heterogenous products because they are an assembly of many components, each of which may vary widely in its compositions and levels of its impurities. In general, a lithium ion battery may contain an anode, a cathode, a separator, and an electrolyte. These components can be provided within packaging which can be made of steel or an aluminum/polymer pouch material.

The anode can comprise a host for accumulating lithium, e.g., graphite/graphene, laid over a substrate, e.g., copper, aluminum, and/or oxides thereof. The selection of cathode compositions in lithium ion batteries varies greatly. The cathode can comprise lithium cobalt oxide, lithium nickel cobalt aluminum oxide, lithium iron phosphate, or lithium nickel manganese cobalt oxide, to give a few examples. The electrolyte can also vary greatly in composition. The electrolyte can be an organic liquid or a polymer, and the electrolyte can contain various additives within, such as surfactants. The electrolyte can contain various lithium salts, such as LiFSI, LiTFSI, LiPF₆, LiCl, LiNO₃, to name a few. Thus, recovering lithium with high purity would involve separating lithium from highly heterogenous and complex compositions.

In some aspects, the present disclosure provides systems and methods of electrorefining lithium to make lithium metal of high purity. As used herein, “electrorefining” can refer to a process that uses electrolysis to purify one or more metals. For example, when electrorefining can comprise using electrolysis to purify lithium from one or more metals from a lithium source, the electrorefined lithium can have higher purity than that of lithium in the lithium source. Electrorefining can involve electrochemically stripping lithium from a lithium source, thereby producing lithium ions. Electrorefining can further involve electrochemically depositing the lithium ions on a substrate to create lithium metal.

Electrorefining can provide an advantage in extracting lithium from a lithium source, such as lithium waste. Electrorefining can preferentially remove the most electropositive element from the lithium source. As lithium is the most electropositive element in the periodic table, lithium can be preferentially extracted from the lithium source although there may be other positively charged ions present in the lithium source (e.g., Cu⁺², Co⁺², Co⁺³, Ni⁺¹, Ni⁺², etc.). Therefore, any cathodic impurities (e.g., metal ions other than lithium ions) found in common types of lithium scrap can be decreased in the electrorefined lithium metal. Moreover, a lithium-selective membrane can be used to prevent or at least reduce the extraction of such impurities while extracting lithium from the lithium source.

In some aspects, the present disclosure provides systems and methods of electrorefining a lithium source to make lithium metal. The lithium metal can be deposited on a substrate to make a lithium metal electrode. The lithium metal electrode can be incorporated into a battery, or it itself can be used as a source of lithium. For example, a lithium source can be electrorefined one or a plurality of times. Multiple electrorefining steps can be performed using a system or method disclosed herein.

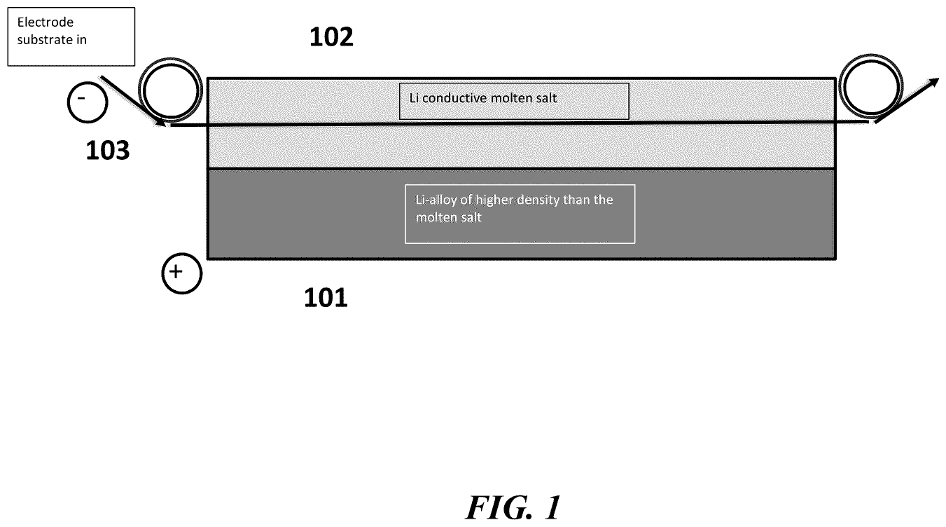

FIG. 1 shows a system for electrorefining lithium metal, in accordance with some embodiments. The lithium source 101 can be positioned below an electrolyte 102 (e.g., a molten salt). The lithium source can be alloyed with another metal, such that the lithium source has higher density than the electrolyte. For example, the alloying metal can be Sn, Pb, Bi, Sb, Zn, or any combination thereof. The alloying can increase the density of the lithium source, thereby allowing the lithium source to be positioned below the electrolyte. Positioning the lithium source below the electrolyte can prevent or reduce the exposure of the lithium source with the atmosphere. Furthermore, the high-purity lithium liquid is less dense than the electrolyte and so will float on it. Alloying the impure lithium separates it from the electrolyte and the pure lithium so that the three phases lie on top of one another, sorted by density. The alloying can be performed by physically introducing the impure lithium with another metal at a temperature high enough that the resultant alloy is a liquid.

A substrate 103 can be provided in contact with the electrolyte. The substrate can be immersed in the electrolyte, such that both sides of the substrate are in contact with the electrolyte. The lithium source and the substrate can be in contact with the electrolyte at the same time.

An electrical potential can be applied so that the lithium source is polarized positively, and the substrate is polarized negatively. By applying the electrical potential, lithium in the lithium source can be electrochemically stripped to enrich the electrolyte with lithium ions. The lithium ions from the electrolyte can be deposited as lithium metal onto the substrate. The electrorefining of lithium from a lithium source, and the making of a lithium metal electrode can be performed simultaneously, or in one step. The electrochemical stripping and the electrochemical deposition can be performed within the same electrochemical cell.

The substrate can be moved through the electrolyte while electrochemical deposition of lithium metal onto the substrate proceeds. This can allow continuous deposition of lithium metal onto the substrate. In some cases, the substrate can be static while the electrochemical deposition is performed.

The electrochemically deposition can be performed a temperature above the melting point of lithium metal. As a result, the lithium metal can be deposited as a liquid. The electrochemical deposition can be performed a temperature below the melting point of lithium metal. As a result, the lithium metal can be deposited as a solid. The electrochemical deposition can be performed at a temperature of at least 180 °C, 180.5 °C, 181 °C, 185 °C, 190 °C, 195 °C, 200 °C, 250 °C, 300 °C, 350 °C, 400 °C, 500 °C, 600 °C, 700 °C, 800 °C, or 900 °C. The electrochemical deposition can be performed at a temperature of at most 200 °C, 250 °C, 300 °C, 350 °C, 400 °C, 500 °C, 600 °C, 700 °C, 800 °C, 900 °C, 1000 °C.

Certain impurities can localize at various surfaces and interfaces of the system. For example, light impurities can localize at the top surface of the electrolyte. Some impurities can localize at the interface between the electrolyte and the lithium source. Some impurities can localize at the bottom of the electrolyte. These impurities can be removed from the system, for example, by scraping the top surface, the interface, or the bottom surface. The impurities can also be removed by tapping the system at the top surface, the interface, or the bottom surface.

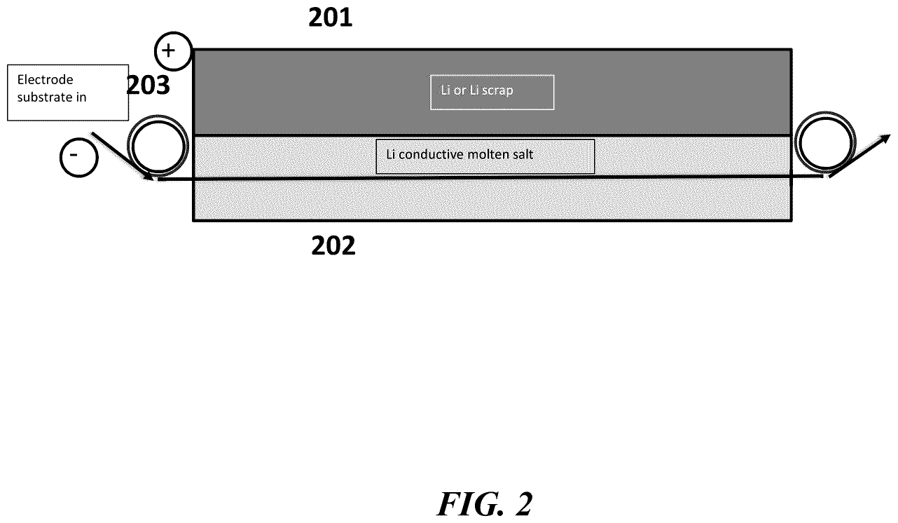

FIG. 2 shows a system for electrorefining lithium metal, in accordance with some embodiments. The lithium source 201 can be positioned above an electrolyte 202 (e.g., a molten salt). The electrolyte can have a higher density than the lithium source. For example, the electrolyte can be a molten salt comprising Li⁺, Na⁺, K⁺, Mg⁺², Al⁺³, B⁺³, or any combination thereof, and Cl⁻, F⁻, Br⁻, or any combination thereof. The electrolyte can comprise elements that are heavier than lithium, which can lead to the electrolyte having higher density than that of lithium.

An electrical potential can be applied so that the lithium source is polarized positively, and the substrate is polarized negatively. By applying the electrical potential, lithium in the lithium source can be electrochemically stripped to enrich the electrolyte with lithium ions. The lithium ions from the electrolyte can be deposited as lithium metal onto the substrate. The electrorefining of lithium from a lithium source, and the making of a lithium metal electrode can be performed simultaneously, or in one step. The electrochemical stripping and the electrochemical deposition can be performed within the same electrochemical cell.

The substrate can be moved through the electrolyte while electrochemical deposition of lithium metal onto the substrate proceeds. This can allow continuous deposition of lithium metal onto the substrate. In some cases, the substrate can be static while the electrochemical deposition is performed.

The electrochemical deposition can be performed a temperature above the melting point of lithium metal. As a result, the lithium metal can be deposited as a liquid. The electrochemical deposition can be performed a temperature below the melting point of lithium metal. As a result, the lithium metal can be deposited as a solid.

Certain impurities can localize at various surfaces and interfaces of the system. For example, light impurities can localize at the top surface of the electrolyte. Some impurities can localize at the interface between the electrolyte and the lithium source. Some impurities can localize at the bottom of the lithium source. These impurities can be removed from the system, for example, by scraping the top surface, the interface, or the bottom surface. The impurities can also be removed by tapping the system at the top surface, the interface, or the bottom surface.

In some cases, the electrorefined lithium metal can be in a liquid state. A substrate can be contacted with the liquid lithium metal to adhere at least a fraction of the liquid lithium metal on the substrate. The substrate and the fraction of the liquid lithium metal can be separated from the liquid lithium metal to produce a lithium metal electrode. The lithium metal electrode can subsequently be used to fabricate a negative electrode for a lithium metal battery. In some cases, the lithium metal electrode can be incorporated into a battery as the negative electrode.

The melting point of lithium is about 180.5 °C. Thus, in order to maintain the liquid lithium metal bath, the liquid lithium metal bath can be maintained at a temperature of at least 180.5 °C. When the lithium metal is a liquid, the substrate can be moved through the liquid lithium metal. The liquid lithium metal can allow continuous deposition of lithium metal on the substrate. This method of depositing lithium on the substrate by immersing the substrate in purified liquid lithium can be distinguished from electrodepositing lithium onto the substrate that is polarized negatively and immersed in the electrolyte, where the lithium is electrodeposited out of the electrolyte. The substrate can be contacted with the liquid lithium metal to deposit lithium metal on one or two sides of the substrate. The substrate can be contacted with the liquid lithium metal at a temperature of at least 180 °C, 180.5 °C, 181 °C, 185 °C, 190 °C, 195 °C, 200 °C, 250 °C, 300 °C, 350 °C, 400 °C, 500 °C, 600 °C, 700 °C, 800 °C, or 900 °C. The substrate can be contacted with the liquid lithium metal at a temperature of at most 200 °C, 250 °C, 300 °C, 350 °C, 400 °C, 500 °C, 600 °C, 700 °C, 800 °C, 900 °C, 1000 °C.

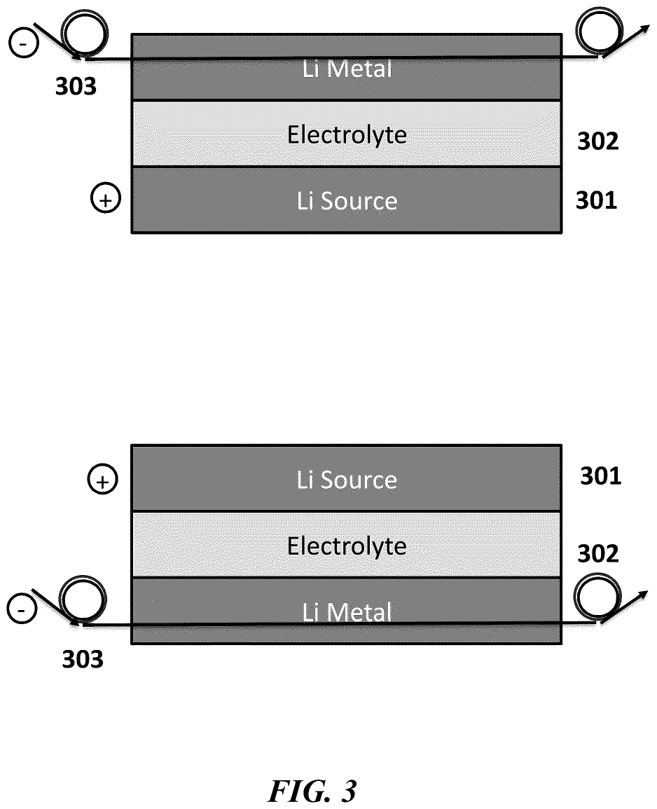

FIG. 3 shows a schematic of a system for electrorefining lithium metal to make liquid lithium metal. The lithium source 301 can be positioned above or below an electrolyte 302 (e.g., a molten salt). The lithium source can be alloyed with another metal, which can provide the lithium source higher density than the electrolyte. For example, the alloying metal, having higher density than lithium, could be Sn, Pb, Bi, Sb, Zn, or any combination thereof. The alloying can increase the density of the lithium source, thereby allowing the lithium to be positioned below the electrolyte.

A substrate 303 can be positioned in the electrolyte opposite the source of impure lithium. An electrical potential can be applied so that the lithium source is polarized positively, and the substrate is polarized negatively. Under the influence of applied electrical potential, lithium in the lithium source can be electrochemically stripped to enrich the electrolyte with lithium ions. The lithium ions from the electrolyte can be reduced to liquid lithium metal, forming a phase of lithium metal separate from the electrolyte. The substrate can be in contact with the liquid lithium metal produce electrolytically, such that at least a part of the liquid lithium metal adheres to the substrate.

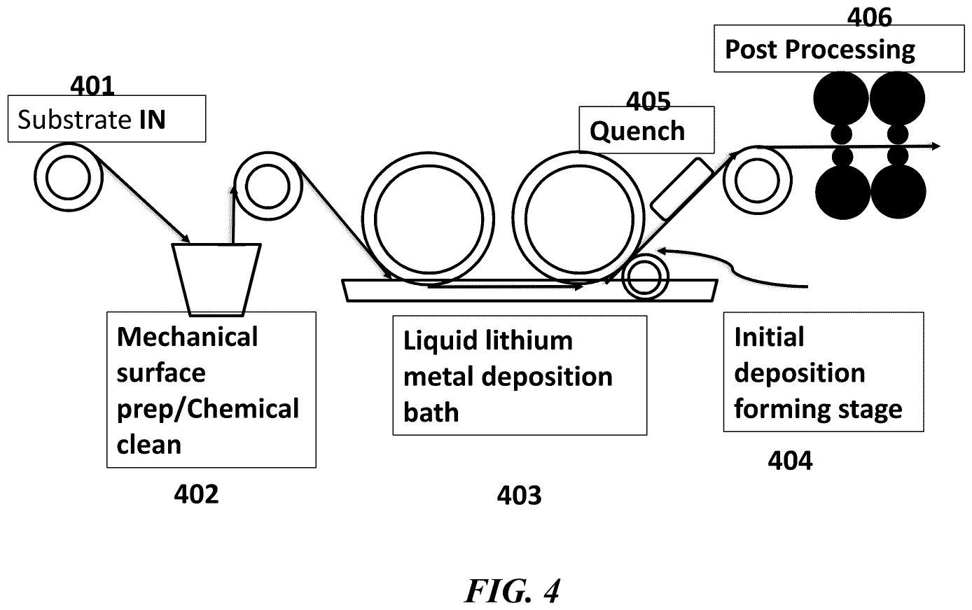

FIG. 4 shows a schematic of a system for contacting a substrate with liquid lithium metal. A substrate 401 can be provided into the system. The substrate can be pretreated 402, e.g., via mechanical surface preparation, or chemical cleaning. The substrate can be submerged in a bath of liquid lithium metal 403, where the lithium metal can be deposited on one or both sides of the substrate. The substrate with the lithium metal can be formed 404, quenched 405, which can solidify the lithium metal. The lithium metal electrode can undergo further post-processing 406.

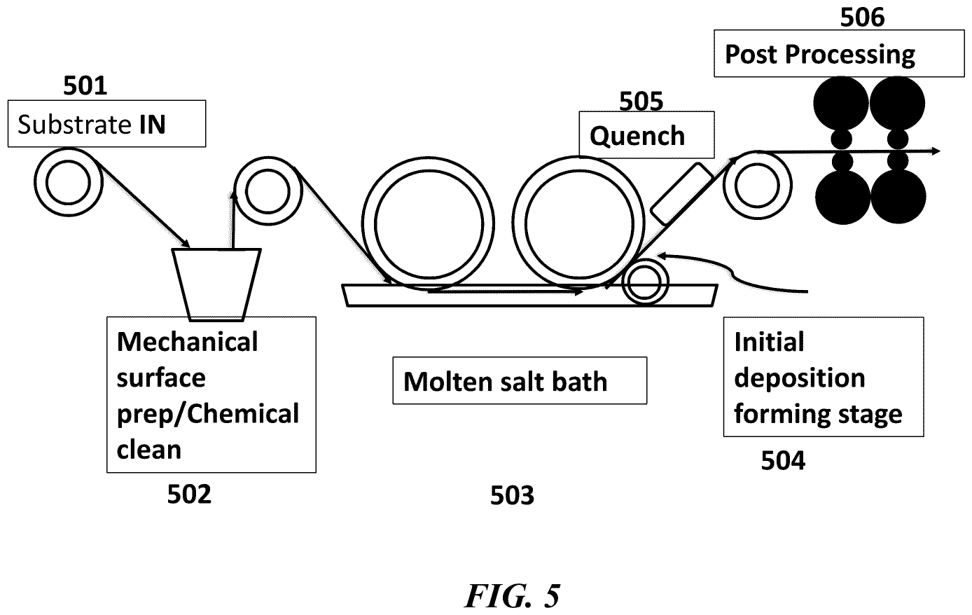

FIG. 5 shows a schematic of a system for contacting a substrate with a molten salt enriched with lithium ions. A substrate 501 can be provided into the system. The substrate can be pretreated 502, e.g., via mechanical surface preparation, or chemical cleaning. The substrate can be submerged in a bath of molten salt 503, where the lithium metal can be electrodeposited on one or both sides of the substrate. The lithium metal can be deposited as a solid, or as a liquid. The substrate with the lithium metal can be formed 504, quenched 505, which can solidify the lithium metal. The lithium metal electrode can undergo further post-processing 506.

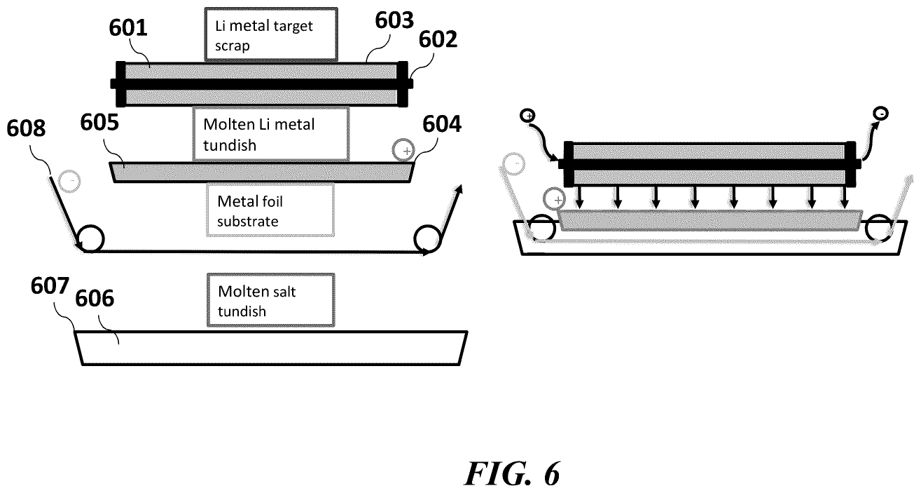

FIG. 6 shows a schematic of a system for contacting a substrate with a molten salt enriched with lithium ions. A lithium source 601 can be heated (e.g., joule heated) to remove the lithium metal from the lithium source to produce liquid lithium metal. The heating can be performed by heating a heating element 602. The heating element can provide heat to the lithium source by resistive heating of the heating element. The lithium source can be provided in a compartment 603 with the heating element. The compartment can be stationary, or it can be configured to rotate the lithium source. The lithium source can be positioned above a tundish 604, or a reservoir. The liquid lithium metal can flow or drip from the lithium source to the tundish. The tundish can be an open bottom vessel configured to contain the liquid lithium metal. The tundish can comprise various chemically inert materials. For example, the tundish can comprise stainless steel, 300 series stainless steel, graphite, a refractory oxide ceramic, a nitride ceramic, or another material configured to hold the liquid lithium metal above the melting point of liquid lithium metal. The liquid lithium metal 605 can be positively charged. The liquid Li metal can be floated a molten salt 606. The molten salt can be held in a tundish 607. A substrate 608 can be conveyed through the molten salt while the substrate is negatively charged, which can allow the electrodeposition of lithium metal onto the substrate. The substrate can be electrodeposited with lithium metal on both sides of the substrate.

The lithium metal electrode can be quenched. Quenching can solidify the fraction of the liquid lithium metal on the substrate into solid lithium metal. The quenching can be performed using a heat sink. The heat sink can comprise cooled copper or aluminum. The heat sink can comprise a roller.

The lithium metal electrode can be post-processed. The lithium metal electrode can be calendared, cleaned, or cut. A solid electrolyte interphase can be formed on a surface of the lithium metal electrode. The lithium metal electrode can be treated an imposed solid, a liquid, or a powder.

### Substrate

The substrate can be a solid. The substrate can comprise a current collector. The current collector can comprise copper, a copper alloy, aluminum, an aluminum alloy, titanium, a titanium alloy, nickel, a nickel alloy, titanium, a titanium alloy, carbon, a polymer, stainless steel, or any combination thereof. The current collector can comprise a melting point higher than the melting point of lithium metal.

The substrate can be pretreated. The substrate can be pretreated by mechanically abrading the surface of the substrate. The mechanically abrading is performed using a wire brush, sandpaper, media blasting, plasma cleaning, or any combination thereof.

The substrate can be pretreated using laser etching, electrochemical oxidation, chemical etching, or any combination thereof.

The substrate can be pretreated by chemically cleaning the substrate to remove kerf from the surface. The chemically cleaning is performed using a molten salt bath, an acidic or a caustic wash, electropolishing, a providing a functional coating, or any combination thereof.

The substrate can comprise one or a number of various coatings, layers, or finishings on a surface of the substrate, or on opposing surfaces of the substrate.

The substrate can comprise a protective layer. The protective layer can comprise nickel, cobalt, chromium, iron, titanium, or any combination thereof. The protective layer can prevent or reduce the formation of cracks in a current collector of the substrate. The protective layer can be deposited on the substrate, e.g., via electrodeposition. The protective layer can comprise a thickness of at least 5, 10, 20, 30, 40, 50, 60, 70, 80, 90, 100, 200, 300, 400, 500, 600, 700, 800, 900, or 1000 nm. The protective layer can comprise a thickness of at most 5, 10, 20, 30, 40, 50, 60, 70, 80, 90, 100, 200, 300, 400, 500, 600, 700, 800, 900, or 1000 nm.

The substrate can comprise a lithiophilic layer. The lithiophilic layer can provide the substrate with an affinity for lithium. Various methods can be used to form the lithiophilic layer on the substrate, e.g., plasma treatment. The lithiophilic layer can be deposited on the substrate, e.g., via electrodeposition. The lithiophilic layer can comprise CuO, Cu₂O, ZnO, MnO₂, SnO₂, Cu, Au, Mg, Al, In, B, Zn, Sn, Si, SiO₂, SiOₓ, a metal fluoride, a metal boride, or any combination thereof. The lithiophilic layer can comprise a thickness of at least 5, 10, 20, 30, 40, 50, 60, 70, 80, 90, 100, 200, 300, 400, 500, 600, 700, 800, 900, or 1000 nm. The lithiophilic layer can comprise a thickness of at most 5, 10, 20, 30, 40, 50, 60, 70, 80, 90, 100, 200, 300, 400, 500, 600, 700, 800, 900, or 1000 nm. The lithiophilic layer can provide a lithium contact angle of less than 90, 80, 70, 60, 50, 40, or 30 degrees. The lithiophilic layer can provide a lithium contact angle of greater than 80, 70, 60, 50, 40, 30, or 20 degrees.

The substrate can comprise a thickness of at least 1, 2, 3, 4, 5, 6, 7, 8, 9, 10, 20, 30, 40, 50, 60, 70, 80, 90, 100, 200, 300, 400, 500, 600, 700, 800, 900, or 1000 μm. The substrate can comprise a thickness of at most 1, 2, 3, 4, 5, 6, 7, 8, 9, 10, 20, 30, 40, 50, 60, 70, 80, 90, 100, 200, 300, 400, 500, 600, 700, 800, 900, or 1000 μm. The substrate can comprise a material web. The substrate can comprise a foil, a mesh, a cloth, or a foam.

The substrate can be contacted with the liquid lithium metal to form an alloy between the liquid lithium metal and the substrate. The alloy can be formed at an interface between the liquid lithium metal and the substrate. The alloy can comprise lithium and copper, zinc, manganese, tin, gold, magnesium, aluminum, indium, boron, silicon, or any combination thereof.

### Lithium Source

The lithium source can comprise lithium scrap, lithium waste, battery waste, or any combination thereof. The lithium source can comprise a component of a lithium-ion battery, lithium metal battery, lithium sulfur battery, or any lithium containing battery.

The lithium source can be one or a combination of various cathode materials, e.g., lithium cobalt oxide, lithium nickel cobalt aluminum oxide, lithium iron phosphate, or lithium nickel manganese cobalt oxide. In some cases, the lithium source can be black mass, or LiFePO₄ separated from batteries.

The lithium source can be an electrolyte. The electrolyte can comprise an electrolyte from a recycled battery, e.g., an organic electrolyte having various lithium salts.

The lithium source can be lithium metal. The lithium metal can be lithium metal that has been electrorefined using a method of the present disclosure. The lithium metal can be alloyed with another metal. The lithium source can be alloyed with another metal, such that the lithium source has higher density than the electrolyte. For example, the alloying metal can be Sn, Pb, Bi, Sb, Zn, or any combination thereof. The alloying can increase the density of the lithium source, thereby allowing the lithium source to be positioned below the electrolyte.

### Electrolyte

The electrorefining can be performed using an electrolyte that separates the lithium source from the liquid lithium metal. The electrolyte can comprise a molten salt. A temperature of the electrolyte can be at least 180 °C, 180.5 °C, 181 °C, 185 °C, 190 °C, 195 °C, 200 °C, 250 °C, 300 °C, 350 °C, 400 °C, 500 °C, 600 °C, 700 °C, 800 °C, or 900 °C. A temperature of the electrolyte can be at most 200 °C, 250 °C, 300 °C, 350 °C, 400 °C, 500 °C, 600 °C, 700 °C, 800 °C, 900 °C, 1000 °C.

### Facility

Systems and methods of the present disclosure can be used or performed in a manufacturing facility. Lithium metal electrodes produced can be integrated into a battery manufacturing process.

In some embodiments, all of the steps in the method are performed at a single manufacturing facility. In some embodiments, the facility is contained in an area of no greater than 10 km². In some embodiments, the facility is contained in an area less than about 1 km². The facility can be operatively coupled to a battery facility for making lithium metal batteries. The facility and the battery facility can be contained in an area of no greater than 10 km². The manufacturing facility and the battery facility can be contained in an area of no greater than 1 km².

### LIST OF EMBODIMENTS

The following list of embodiments of the invention are to be considered as disclosing various features of the invention, which features can be considered to be specific to the particular embodiment under which they are discussed, or which are combinable with the various other features as listed in other embodiments. Thus, simply because a feature is discussed under one particular embodiment does not necessarily limit the use of that feature to that embodiment.

Embodiment 1. A method of making a lithium metal electrode, comprising:
(a) electrorefining a lithium source to produce liquid lithium metal;
(b) contacting a substrate with the liquid lithium metal to adhere at least a fraction of the liquid lithium metal on the substrate; and
(c) separating the substrate and the fraction of the liquid lithium metal from the liquid lithium metal to produce the lithium metal electrode.

Embodiment 2. The method of embodiment 1, further comprising pretreating the substrate.

Embodiment 3. The method of embodiment 2, wherein the pretreating comprises mechanically abrading the surface of the substrate.

Embodiment 4. The method of embodiment 3, wherein the mechanically abrading is performed using a wire brush, sandpaper, media blasting, plasma cleaning, or any combination thereof.

Embodiment 5. The method of embodiment 2, wherein the pretreating comprises chemically cleaning the substrate to remove kerf from the surface.

Embodiment 6. The method of embodiment 5, wherein the chemically cleaning is performed using a molten salt bath, an acidic or a caustic wash, electropolishing, a functional coating, or any combination thereof.

Embodiment 7. The method of embodiment 1, wherein the contacting is performed at a temperature of at least 180 °C, 180.5 °C, 181 °C, 185 °C, 190 °C, 195 °C, 200 °C, 250 °C, 300 °C, 350 °C, 400 °C, 500 °C, 600 °C, 700 °C, 800 °C, or 900 °C.

Embodiment 8. The method of embodiment 1, wherein the contacting is performed at a temperature of at most 200 °C, 250 °C, 300 °C, 350 °C, 400 °C, 500 °C, 600 °C, 700 °C, 800 °C, 900 °C, 1000 °C.

Embodiment 9. The method of embodiment 1, wherein the contacting comprises moving the substrate through the liquid lithium metal.

Embodiment 10. The method of embodiment 1, wherein the contacting comprises contacting the substrate with the liquid lithium metal on two sides of the substrate.

Embodiment 11. The method of embodiment 1, further comprising quenching the lithium metal electrode.

Embodiment 12. The method of embodiment 11, wherein the quenching solidifies the fraction of the liquid lithium metal on the substrate into solid lithium metal.

Embodiment 13. The method of embodiment 11, wherein the quenching is performed using a heat sink.

Embodiment 14. The method of embodiment 13, wherein the heat sink comprises cooled copper or aluminum.

Embodiment 15. The method of embodiment 13, wherein the heat sink comprises a roller.

Embodiment 16. The method of embodiment 15, further comprising calendaring the lithium metal electrode.

Embodiment 17. The method of embodiment 16, further comprising cleaning the lithium metal electrode.

Embodiment 18. The method of embodiment 17, further comprising cutting the lithium metal electrode.

Embodiment 19. The method of embodiment 18, further comprising forming a solid electrolyte interphase on a surface of the lithium metal electrode.

Embodiment 20. The method of embodiment 19, further comprising treating the lithium metal electrode with an imposed solid, a liquid, or a powder.

Embodiment 21. The method of embodiment 1, wherein the lithium source comprises LiFePO4.

Embodiment 22. The method of embodiment 1, wherein the lithium source comprises lithium scrap, lithium waste, battery waste, or any combination thereof.

Embodiment 23. The method of embodiment 1, wherein the substrate comprises copper, a copper alloy, aluminum, an aluminum alloy, titanium, a titanium alloy, stainless steel, or any combination thereof.

Embodiment 24. The method of embodiment 1, wherein the substrate comprises a melting point higher than the melting point of lithium metal.

Embodiment 25. The method of embodiment 1, wherein the substrate comprises a material web.

Embodiment 26. The method of embodiment 1, wherein the substrate comprises a foil, a mesh, a cloth, or a foam.

Embodiment 27. The method of embodiment 1, wherein the contacting forms an alloy between the fraction of the liquid lithium metal and the substrate.

Embodiment 28. The method of embodiment 27, wherein the alloy is formed at an interface between the fraction of the liquid lithium metal and the substrate.

Embodiment 29. The method of embodiment 28, wherein the alloy comprises lithium and copper.

Embodiment 30. The method of embodiment 1, wherein the electrorefining comprising using an electrolyte that separates the lithium source from the liquid lithium metal.

Embodiment 31. The method of embodiment 30, wherein the electrolyte comprises a molten salt.

Embodiment 32. The method of embodiment 30, wherein a temperature of the electrolyte is at least 180.5 °C, 200 °C, 250 °C, 300 °C, 350 °C, 400 °C, 500 °C, 600 °C, 700 °C, 800 °C, or 900 °C.

Embodiment 33. The method of embodiment 1, wherein the contacting is performed at a temperature of at most 200 °C, 250 °C, 300 °C, 350 °C, 400 °C, 500 °C, 600 °C, 700 °C, 800 °C, 900 °C, 1000 °C.

Embodiment 34. The method of embodiment 33, further comprising alloying the lithium source with a metal before electrorefining.

Embodiment 35. The method of embodiment 30, wherein the lithium source is positioned below the electrolyte.

Embodiment 36. The method of embodiment 35, wherein the lithium source has a higher density than the electrolyte.

Embodiment 37. The method of embodiment 36, wherein the liquid lithium metal is positioned above the electrolyte.

Embodiment 38. The method of embodiment 30, wherein the lithium source is positioned above the electrolyte.

Embodiment 39. The method of embodiment 38, wherein the lithium source has a lower density than the electrolyte.

Embodiment 40. The method of embodiment 39, wherein the liquid lithium metal is positioned below the electrolyte.

Embodiment 41. The method of embodiment 40, wherein the metal is denser than lithium.

Embodiment 42. The method of embodiment 41, wherein the metal comprises Sn, Pb, Bi, Sb, Zn, or any combination thereof.

Embodiment 43. The method of embodiment 1, wherein the electrorefining is performed using a polarized electrode configured to attract lithium ions, from the lithium source positioned below the electrolyte, to the liquid lithium metal positioned above the electrolyte.

Embodiment 44. The method of embodiment 43, wherein the electrorefining reduces the lithium ions to produce the liquid lithium metal.

Embodiment 45. A method of making a lithium metal electrode, comprising:
(a) electrochemically stripping a lithium source to enrich a molten salt with lithium ions; and
(b) electrochemically depositing the lithium ions as lithium metal onto a substrate, wherein the substrate is in contact with the molten salt.

Embodiment 46. The method of embodiment 45, wherein the electrochemically stripping and the electrochemically depositing is performed simultaneously.

Embodiment 47. The method of embodiment 45, wherein the electrochemically stripping and the electrochemically depositing are performed within the same electrochemical cell.

Embodiment 48. The method of embodiment 45, wherein the lithium source and the substrate are in contact with the molten salt at the same time.

Embodiment 49. The method of embodiment 45, wherein the lithium source and the substrate are electrically polarized.

Embodiment 50. The method of embodiment 49, wherein the lithium source is polarized positively, and the substrate is polarized negatively.

Embodiment 51. The method of embodiment 45, wherein the lithium metal is deposited as a liquid.

Embodiment 52. The method of embodiment 51, wherein the electrochemically depositing is performed a temperature above the melting point of lithium metal.

Embodiment 53. The method of embodiment 45, wherein the lithium metal is deposited as a solid.

Embodiment 54. The method of embodiment 53, wherein the electrochemically depositing is performed a temperature below the melting point of lithium metal.

Embodiment 55. The method of embodiment 54, further comprising alloying the lithium source with a metal before the electrochemically stripping.

Embodiment 56. The method of embodiment 55, wherein the alloyed lithium source is positioned below the molten salt.

Embodiment 57. The method of embodiment 56, wherein the alloyed lithium source has a higher density than the molten salt.

Embodiment 58. The method of embodiment 55, wherein the metal higher density than lithium.

Embodiment 59. The method of embodiment 58, wherein the metal comprises Sn, Pb, Bi, Sb, Zn, or any combination thereof.

Embodiment 60. The method of embodiments 45, wherein the lithium source is positioned above the molten salt.

Embodiment 61. The method of embodiment 60, wherein the lithium source has a lower density than the molten salt.

Embodiment 62. The method of embodiment 61, wherein the molten salt comprises Li+, Na+, K+, Mg+2, Al+3, B+3, or any combination thereof, and Cl−, F−, Br−, or any combination thereof.

Embodiment 63. The method of embodiment 45, wherein the lithium source comprises LiFePO4.

Embodiment 64. The method of embodiment 45, wherein the lithium source comprises lithium scrap, lithium waste, battery waste, lithium metal, lithium alloy, liquid lithium metal, or any combination thereof.

Embodiment 65. The method of embodiment 64, further comprising removing impurities from the top surface of the molten salt.

Embodiment 66. The method of embodiment 65, further comprising removing impurities from the top surface of the lithium source.

Embodiment 67. The method of embodiment 66, further comprising removing impurities from the interface between the lithium source and the molten salt.

Embodiment 68. The method of embodiment 65, wherein the removing comprises scraping the surface.

Embodiment 69. The method of embodiment 68, further comprising removing impurities from the bottom of the lithium source.

Embodiment 70. The method of embodiment 69, wherein the removing comprises tapping off the bottom.

Embodiment 71. The method of embodiment 45, wherein the electrochemical deposition is performed while moving the substrate through the liquid lithium metal.

Embodiment 72. The method of embodiment 45, wherein the lithium source comprises liquid lithium metal.

Embodiment 73. The method of embodiment 72, further comprising producing the liquid lithium metal by melting lithium metal in lithium scrap, lithium waste, battery waste, lithium alloy, or any combination thereof.

Embodiment 74. The method of embodiment 73, further comprising incorporating the lithium metal electrode into a lithium metal battery.

Embodiment 75. The method of embodiment 74, wherein the lithium metal electrode is incorporated into the lithium metal battery at a distance of less than 10, 9, 8, 7, 6, 5, 4, 3, 2, or 1 km from where the lithium metal electrode is produced.

Embodiment 76. A system for making a lithium metal electrode, comprising:
an electrochemical cell configured to electrorefine a lithium source to produce liquid lithium metal; and
a substrate in contact with the liquid lithium metal.

Embodiment 77. The system of embodiment 76, further comprising a conveyor configured to convey the substrate through the liquid lithium metal.

Embodiment 78. The system of embodiment 77, wherein the conveyor comprises a plurality of rollers.

Embodiment 79. The system of embodiment 78, wherein a roller in the plurality of rollers is domed or formed to keep tabs of the substrate out of the liquid lithium metal.

Embodiment 80. The system of embodiment 78, wherein a roller in the plurality of rollers is at least partially submerged in the liquid lithium metal.

Embodiment 81. The system of embodiment 78, wherein a roller in the plurality of rollers is configured to allow the substrate to be submerged in the liquid lithium metal.

Embodiment 82. The system of embodiment 78, wherein a roller in the plurality of rollers comprises a predetermined gap to calendar the lithium metal electrode.

Embodiment 83. The system of embodiment 78, wherein a roller in the plurality of rollers comprises a lithiophilic surface.

Embodiment 84. The system of embodiment 78, wherein the lithiophilic surface provides a wetting angle of greater than 90°.

Embodiment 85. The system of embodiment 84, further comprising a quencher.

Embodiment 86. The system of embodiment 85, wherein the quencher comprises chilled heat sink.

Embodiment 87. The system of embodiment 86, wherein the heat sink comprises copper or aluminum.

Embodiment 88. The system of embodiment 85, wherein the quencher comprises a chilled roller.

Embodiment 89. A system for making a lithium metal electrode, comprising:
an electrochemical cell configured to:
   (i) electrochemically strip a lithium source to produce a molten salt comprising lithium; and
   (ii) electrochemically deposit lithium metal onto a substrate in contact with the molten salt.

Embodiment 90. The system of embodiment 89, further comprising a conveyor configured to convey the substrate through the molten salt.

Embodiment 91. The system of embodiment 90, wherein the conveyor comprises a plurality of rollers.

Embodiment 92. The system of embodiment 91, wherein a roller in the plurality of rollers is domed or formed to keep tabs of the substrate out of the liquid lithium metal.

Embodiment 93. The system of embodiment 91, wherein a roller in the plurality of rollers is at least partially submerged in the liquid lithium metal.

Embodiment 94. The system of embodiment 91, wherein a roller in the plurality of rollers is configured to allow the substrate to be submerged in the liquid lithium metal.

Embodiment 95. The system of embodiment 91, wherein a roller in the plurality of rollers comprises a predetermined gap to calendar the lithium metal electrode.

Embodiment 96. The system of embodiment 91, wherein a roller in the plurality of rollers comprises a lithiophilic surface.

Embodiment 97. The system of embodiment 91, wherein the lithiophilic surface provides a wetting angle of greater than 90°.

Embodiment 98. The system of embodiment 97, further comprising a quencher.

Embodiment 99. The system of embodiment 98, wherein the quencher comprises chilled heat sink.

Embodiment 100. The system of embodiment 99, wherein the heat sink comprises copper or aluminum.

Embodiment 101. The system of embodiment 98, wherein the quencher comprises a chilled roller.

Embodiment 102. The system of embodiment 101, further comprising a mechanical abrader configured to pretreat the substrate.

Embodiment 103. The system of embodiment 102, further comprising a chemical cleaner configured to clean the substrate.

Embodiment 104. The system of embodiment 103, wherein the chemical cleaner comprises a molten salt bath, an acidic or a caustic wash, electropolisher, a functional coating depositor or former, or any combination thereof.

Embodiment 105. The system of embodiment 76, wherein the electrochemical cell is held at a temperature of at least 180.5 °C, 200 °C, 250 °C, 300 °C, 350 °C, 400 °C, 500 °C, 600 °C, 700 °C, 800 °C, or 900 °C.

Embodiment 106. The system of embodiment 76, wherein the electrochemical cell is held at a temperature of at most 200 °C, 250 °C, 300 °C, 350 °C, 400 °C, 500 °C, 600 °C, 700 °C, 800 °C, 900 °C, or 1000 °C.

Embodiment 107. The system of embodiment 76, wherein the lithium source comprises LiFePO4.

Embodiment 108. The system of embodiment 76, wherein the lithium source comprises lithium scrap, lithium waste, battery waste, lithium metal, liquid lithium metal, lithium alloy, or any combination thereof.

Embodiment 109. The system of embodiment 76, wherein the substrate comprises copper, a copper alloy, aluminum, an aluminum alloy, titanium, a titanium alloy, stainless steel, or any combination thereof.

Embodiment 110. The system of embodiment 76, wherein the substrate comprises a melting point higher than the melting point of lithium metal.

Embodiment 111. The system of embodiment 76, wherein the substrate comprises a material web.

Embodiment 112. The system of embodiment 76, wherein the substrate comprises a foil, a mesh, a cloth, or a foam.

Embodiment 113. The system of embodiment 76, wherein the contacting forms an alloy between the fraction of the liquid lithium metal and the substrate.

Embodiment 114. The system of embodiment 76, wherein the electrochemical cell comprises an electrolyte.

Embodiment 115. The system of embodiment 114, wherein the electrolyte comprises a molten salt.

Embodiment 116. The system of embodiment 115, wherein the molten salt comprises Li⁺, Na⁺, K⁺, Mg⁺², Al⁺³, B⁺³, or any combination thereof, and Cl⁻, F⁻, Br⁻, or any combination thereof.

Embodiment 117. The system of embodiment 116, further comprising a mixer or a furnace configured to alloy the lithium source with a metal.

Embodiment 118. The system of embodiment 117, wherein the metal comprises Sn, Pb, Bi, Sb, Zn, or any combination thereof.

Embodiment 119. The system of embodiment 76, wherein the deposited lithium metal is a liquid.

Embodiment 120. The system of embodiment 76, wherein the deposited lithium metal is a solid.

Embodiment 121. The system of embodiment 120, further comprising a scraper or a tap configured to remove impurities from the electrochemical cell.

Embodiment 122. The system of embodiment 76, wherein the lithium source comprises liquid lithium metal.

Embodiment 123. The system of embodiment 122, further comprising a compartment configured to produce the liquid lithium metal by melting lithium metal in lithium scrap, lithium waste, battery waste, lithium alloy, or any combination thereof.

Embodiment 124. The system of embodiment 123, wherein the compartment comprises a heating element configured to melt the lithium metal.

Embodiment 125. The system of embodiment 124, wherein the heating element comprises a resistive heating element.

Embodiment 126. The system of embodiment 125, further comprising a tundish configured to hold the liquid lithium metal.

Embodiment 127. The system of embodiment 126, wherein the tundish comprises an open bottom.

Embodiment 128. The system of embodiment 127, wherein the liquid lithium metal is in contact with the electrolyte.

Embodiment 129. The system of embodiment 76, wherein the system is operatively coupled to a lithium metal battery manufacturing system.

Embodiment 130. The system of embodiment 129, wherein the system and the lithium metal battery manufacturing system is contained in an area of no greater than 10, 9, 8, 7, 6, 5, 4, 3, 2, or 1 km².

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby.

1. A method of making a lithium metal electrode, comprising:
a. electrorefining a lithium source to produce liquid lithium metal;
b. contacting a substrate with the liquid lithium metal to adhere at least a fraction of the liquid lithium metal on the substrate; and
c. separating the substrate and the fraction of the liquid lithium metal from the liquid lithium metal to produce the lithium metal electrode.

2. The method of claim 1, further comprising pretreating the substrate.

3. The method of claim 2, wherein the pretreating comprises mechanically abrading the surface of the substrate.

4. The method of claim 3, wherein the mechanically abrading is performed using a wire brush, sandpaper, media blasting, plasma cleaning, or any combination thereof.

5. The method of claim 2, wherein the pretreating comprises chemically cleaning the substrate to remove kerf from the surface.

6. The method of claim 5, wherein the chemically cleaning is performed using a molten salt bath, an acidic or a caustic wash, electropolishing, a functional coating, or any combination thereof.

7. The method of claim 1, wherein the contacting is performed at a temperature of at least 180 °C, 180.5 °C, 181 °C, 185 °C, 190 °C, 195 °C, 200 °C, 250 °C, 300 °C, 350 °C, 400 °C, 500 °C, 600 °C, 700 °C, 800 °C, or 900 °C.

8. The method of claim 1, wherein the contacting is performed at a temperature of at most 200 °°C, 250 °C, 300 °C, 350 °C, 400 °C, 500 °C, 600 °C, 700 °C, 800 °C, 900 °C, 1000 °C.

9. The method of claim 1, wherein the contacting comprises moving the substrate through the liquid lithium metal or contacting the substrate with the liquid lithium metal on two sides of the substrate.

10. The method of claim 1, further comprising quenching the lithium metal electrode.

11. The method of claim 10, wherein the quenching solidifies the fraction of the liquid lithium metal on the substrate into solid lithium metal.

12. The method of claim 11, further comprising (i) calendering the lithium metal electrode, (ii) cleaning the lithium metal electrode, (iii) cutting the lithium metal electrode, (iv) forming a solid electrolyte interphase on a surface of the lithium metal electrode, or (v) treating the lithium metal electrode with an imposed solid, a liquid, or a powder.

13. The method of claim 1, wherein the lithium source comprises LiFePO4.

14. The method of claim 1, wherein the lithium source comprises lithium scrap, lithium waste, battery waste, or any combination thereof.

15. The method of claim 1, wherein the substrate comprises copper, a copper alloy, aluminum, an aluminum alloy, titanium, a titanium alloy, stainless steel, or any combination thereof, and wherein the substrate comprises a melting point higher than the melting point of lithium metal.

16. The method of claim 1, wherein the electrorefining comprises using an electrolyte that separates the lithium source from the liquid lithium metal.

17. The method of claim 16, wherein the electrolyte comprises a molten salt.

18. The method of claim 16, further comprising alloying the lithium source with a metal before electrorefining.

19. The method of claim 16, wherein the lithium source is positioned below the electrolyte or above the electrolyte.

20. The method of claim 1, wherein the electrorefining is performed using a polarized electrode configured to attract lithium ions, from the lithium source positioned below electrolyte, to the liquid lithium metal positioned above the electrolyte.
